(19) United States
(12) Patent Application Publication
(10) Pub. No.: US 2017/0032298 A1
(43) Pub. Date: Feb. 2, 2017

(54) METHODS AND SYSTEMS FOR VISUALIZING INDIVIDUAL AND GROUP SKILL PROFILES

(71) Applicants: Sebastien de Ghellinck, New York, NY (US); Artur Sitdykov, West Windsor, NJ (US); Karunakar Kemisetti, Roslyn, NY (US)

(72) Inventors: Sebastien de Ghellinck, New York, NY (US); Artur Sitdykov, West Windsor, NJ (US); Karunakar Kemisetti, Roslyn, NY (US)

(21) Appl. No.: 15/222,147

(22) Filed: Jul. 28, 2016

Related U.S. Application Data
(60) Provisional application No. 62/198,438, filed on Jul. 29, 2015.

(51) Int. Cl. G06Q 10/06; H04L 29/08; G06F 17/30

(52) U.S. Cl. CPC G06Q 10/0639; G06F 17/30424; H04L 67/306; G06Q 50/01

(57) ABSTRACT

A method and system for managing organizations based on competencies, expertise and experience of their members, including (a) identifying and classifying “competencies” existing within organizations; (b) promoting and creating “interactions” and “engagements” between members based on identified competencies, creating rewards and incentives promoting such interactions; (c) creating virtual “competency exchanges” within organization and “competency marketplaces” across multiple organizations; (d) managing organizations and various ongoing activities of the organizations based on the competency profiles and balance of supply and demand of particular competencies (e) creating valuation of particular competencies; (f) providing analytics and reporting, and other functionality as discussed in greater detail below.

### CLAIM TO PRIORITY

This application claims the priority of U.S. Provisional Application No. 62/198,438, entitled “METHODS AND SYSTEMS FOR VISUALIZING INDIVIDUAL AND GROUP SKILL PROFILES,” filed on Jul. 29, 2015, the disclosure of which is hereby incorporated by reference in its entirety.

### BACKGROUND OF THE INVENTION

The present application relates to computer systems and corresponding methods for use in the field of information analytics, and, more specifically, systems and methods for analyzing individual and group expertise and competencies.

A number of “human resource” applications exist and/or have been proposed. For example, U.S. Pat. No. 6,049,776 proposes a human resource system for use in staffing projects, taking into account the skill and schedule of an employee. Similarly, U.S. Pat. No. 6,718,341 proposes a store employee locator that takes into account expertise of the employee and U.S. Pat. No. 5,111,391 proposes a staff scheduling system that takes into account skills and availability. There are even some that generate user profiles based on user bios, such as U.S. Patent Publication No. 2014/0279798 and 2014/0279629, and yet others that provide analytical tools for locating experts, such as U.S. Pat. No. 7,792,786, and U.S. Patent Publication No. 2013/0218644 and 2009/0276231. Finally, there are some patent publications relating to nameplates, such as U.S. Patent Publication No. 2009/0113311 and U.S. Pat. No. 6,370,395. These proposed systems, however, are significantly limited in terms of usefulness. Accordingly, there is a need for a system that is not so limited and is mixed with physical objects automatically generated by the system, in order to create a richer experience for users and customers.

### SUMMARY OF THE INVENTION

The present application generally provides methods and systems for managing organizations based on competencies, expertise and experience of their members, including (a) identifying and classifying “competencies” existing within organizations; (b) promoting and creating “interactions” and “engagements” between members based on identified competencies, creating rewards and incentives promoting such interactions; (c) creating virtual “competency exchanges” within organization and “competency marketplaces” across multiple organizations; (d) managing organizations and various ongoing activities of the organizations based on the competency profiles and balance of supply and demand of particular competencies (e) creating valuation of particular competencies; (f) providing analytics and reporting, and other functionality as discussed in greater detail below.

In one embodiment, the system comprises a processor, and a memory having executable instructions stored thereon that when executed by the processor cause the processor to search a database of content for competency data associated with a plurality of individuals from an organization, retrieve the competency data associated with the plurality of individuals from the organization based on a set of competency taxonomies, generate profile information for the plurality of individuals by associating the individuals with the identified competency data, receive a search query from a user of a client device, the search query specifying one or more competency criteria, and identify one or more of the plurality of individuals associated with the one or more competency criteria based on the profile information.

The profile information may include name, competencies, personality type, contact information, projects, documents associated with the individuals, and occupational history. The processor can further identify one or more of a plurality of individuals from outside the organization that are associated with the one or more competency criteria. An experts page may be generated by the processor in response to the search query. The experts page may include a plurality of skill badge and skill board data corresponding to the one or more plurality of individuals.

According to one embodiment, the processor may further generate skill badge data based on the profile information for the plurality of individuals. The skill badge data may include name, position, corporate information, and competency characteristics. The database of content may include electronic interactions between the plurality of individuals. In one embodiment, the search query comprises a question or consultation request posted by the user of the client device. In another embodiment, the search query comprises an assignment, project, or full-time job posted by the user of the client device.

The system may further comprise the processor matching a structured opportunity including a type of engagement, duration of the engagement, number of individuals required for the engagement, with individuals who possess the competencies required for the engagement. The processor may also parse a communication medium between parties for a given competency and determine a condition to refer individuals having profiles including the given competency to the parties. Another embodiment further includes the processor receiving endorsement of the competency data from endorsement data sources, and generating validation points based on the endorsement. The processor may also determine a demand for a given competency based on at least one of an amount of profiles of individuals including the given competency, search queries specifying the given competency, and a duration of engagements associated with the given competency.

### BRIEF DESCRIPTION OF THE FIGURES

FIG. 1 depicts the architecture of a system for creating and visualizing skill profiles according to at least one embodiment of the systems discussed herein.

FIG. 2 depicts the flow of data in a system for creating and visualizing skill profiles according to at least one embodiment of the systems discussed herein.

FIG. 3 is an exemplary home page interface screen.

FIG. 4 is an exemplary open discussions page interface screen.

FIG. 5 is an exemplary unit discussions page interface screen.

FIG. 6 is an exemplary experts page interface screen displaying search results, including skill badges.

FIG. 7 is another exemplary experts page interface screen displaying search results, including skill badges.

FIG. 8 is an exemplary individual expert page or “profile page” interface screen.

FIGS. 9-10 depict exemplary skillboard displays.

FIG. 11 depicts an exemplary skill badge.

### DETAILED DESCRIPTION OF THE INVENTION

The present application provides novel systems and methods for structuring and managing the organizations based on competencies of their members. The system may include one or more software tools for (1) identifying and classifying “competencies” (skills, competencies, knowledge, experiences, areas of expertise) offered by the “members” (employees or other types of members) of particular “organizations” (commercial companies, non-commercial organizations, associations, political organizations, universities, online communities, and other formal and informal organizations with multiple members or particular areas of such organizations), as well as “content” related to those competencies (documents, presentations, sets of data, reports, publications, documents, trainings, webcasts and other content), based on use of hierarchical competency taxonomies/ontologies; (2) identifying experts and expertise existing within the organization (internal supply of competencies), or within a group of organizations, or across multiple organizations (market supply of competencies); (3) structuring and managing various ongoing activities of the organizations, including structuring short-term or longer-term working or other individual or group engagements (projects, presentations, sessions, client sales engagements, learning courses, work assignments, full-time working positions) based on matching of competencies offered by particular organization members (or groups of members) and demanded by other members (or areas within organization), either within the organization, or within a group of organizations, or across multiple organizations; (4) structuring organizations (or groups, divisions within organizations) and placing and utilizing members within the organization (or within a group of organizations, or across multiple organizations) based on competency profiles (sets of competencies) offered by particular members and demanded within particular areas of organizations based on organizational goals; (5) promoting and creating individual or group interactions between members (requests for expertise, conversations, phone calls, meetings, web-conferences, consultations), forming groups of members, based on competencies offered by particular organization members; (6) creating endorsements, rewards and incentives mechanism (such as points, medals, merit badges, etc.) promoting interactions and creating motivation for members of organization for sharing their competencies and utilizing them according to the goals of organization; (7) creating virtual “competency exchange” within particular organization, based on the balance of demand and supply for particular competencies within the organization, as well as creating “competency marketplaces” within a group of organizations, or across multiple organizations; (8) creating valuation of particular competencies based on the analysis of demand and supply for particular competencies in “competency exchanges” or “competency marketplaces”; (9) identifying adequacy of amounts of particular competencies existing within organization and offered by members of organization to organization's strategic goals (‘deficit’ or ‘over-supply’ of particular competencies); and (10) creating analytics and providing reporting based on the analysis of demand and supply for particular competencies within organization and across organizations. Each of these functionalities will be discussed below in relation to the SkillCollider™ system.

The SkillCollider™ system generally includes one or more special purpose computing devices coupled over a communication network to one or more client devices. The system, for example, may include at least one server computer having a processor, a memory, and a network interface. The memory preferably includes therein executable code enabling the functionality of the special purpose computer discussed herein, including causing the various interface screens, storing information in the various data bases, and identifying information from the data bases in response to user queries. A client device may be a personal computer, laptop, a smart phone or tablet computer, display devices, such as a monitor or television screen, or a special purpose device with specifically designed features as discussed herein. The system preferably includes at least one database coupled to the one or more special purpose computing devices.

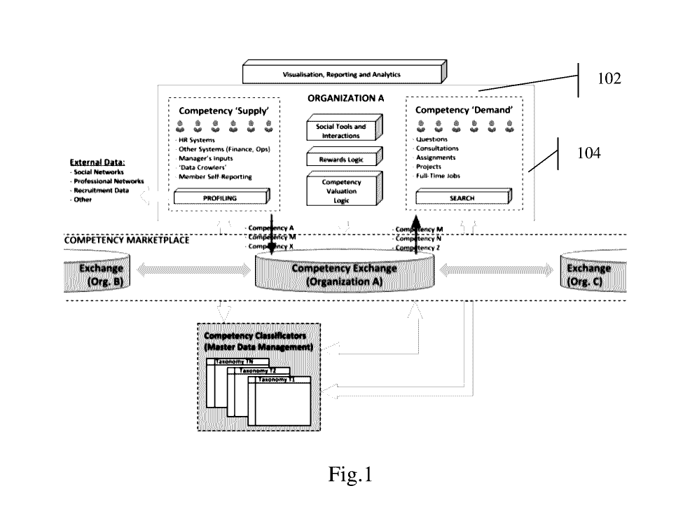

Referring to FIG. 1, the system includes at least one computing device 102, such as a server computer. The computing device 102 includes executable code that provides the functionality discussed herein. It is anticipated that the SkillCollider™ system may be provided to users in the form of software-as-a-service (SaaS) or software-as-a-platform (SaaP). Accordingly, the system may provide one or several application(s) and/or module(s) 104 specific to each of a plurality of organizations, e.g., for Organization A, B, C, etc. The system may therefore provide a module for Organization A, which builds a competency exchange for Organization A. The corresponding module for Organization B may similarly build an exchange for Organization B, a module for Organization C builds an exchange for Organization C, etc. The competency exchange is a data store that generally includes a data set of profile information for each of a plurality of individuals and/or groups associated with the organization. This profile data set may include personal information (name, ID, photo, etc.), corporate position information (position, department, symbol for officer title, location, time, etc.), personality profile (personality type, symbol, etc.), and/or skills/competencies (hard skills, aspiration skills, languages known, etc., extracted from a databank of competencies). The competencies are preferably classified using one or more predefined taxonomies/ontologies (hereinafter referred to simply as taxonomies). Competencies included in the databank of competencies may be defined as professional skills, functional skills, geographical presence, past organizations worked at, occupational skills, services or products worked on, technologies and computer systems fluency and others. The competencies to be included in the databank can vary from instance to instance. The competencies to be included in the databank can be extracted from public sources of information, open sources of information. The databank of competencies can be updated, managed and structured via an ongoing manual process, via Semantic Web analysis technologies, Linked Open Data technologies, other semantic intelligence technologies, other artificial intelligence technologies or via other automated processes.

The profile information may be assembled from various sources, including internal and external sources. The external sources may be one or more social networks, professional networks, recruitment data, etc. In this regard, the system retrieves the data by communicating, e.g., with a third party application program interface (“API”) that makes the data available for download. Alternatively, the system may scrape the data from the third party data set using, for example, a data crawler or scraping robot. The internal source may be a human resource (HR) database or any other database maintained by the organization, such as the databases associated with finance or operations systems, etc. The module may similarly access this information via a direct file upload, an API or a data crawler. The profile information may additionally be obtained with a self-reporting interface, which includes therein form elements for the user to specify profile information. The profile may also be enriched with competencies suggested by co-workers.

The exchange preferably includes competency “demand” information. This information is generally data that represents information obtained in connection with a competency need, such as questions directed toward experts and relevant responses, consultations, assignments, projects, full-time jobs, etc. The demand data may be obtained with one or more of the various interfaces discussed herein. The module 104 may therefore include logic that facilitates social tools and interactions, maintains rewards, competency valuation, etc., with the one or more interfaces of the present application.

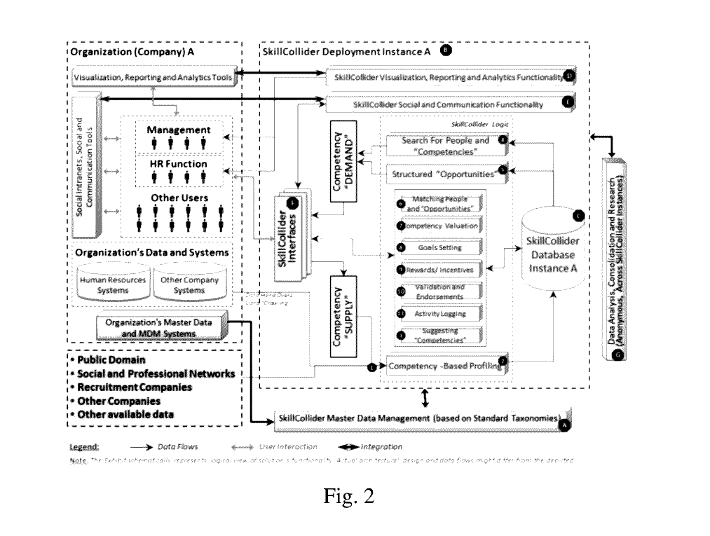

FIG. 2 represents conceptual view and key logical blocks of functionality for the SkillCollider™ system according to at least one embodiment. This system (at least one special purpose computing devices, interface(s), application(s) and database(s)) provides functionality for managing the organizations (or particular activities within organizations) based on competencies of their members. Logic and functional design of the system is aligned to demand and supply of competencies within organizations. Note, not all existing data flows and interactions between particular modules are shown. Actual software and database architecture and design as well as associated data flows can differ from those depicted in the Fig. FIG. 2, therefore, represents an exemplary one of many possible combinations.

A: Master Data Management (MDM) Module

The Master Data Management provides consistent framework and allows data integration across all functional blocks of SkillCollider™ deployment instance as well as across multiple deployment instances. This may be achieved by providing consistent classification of competencies based on a set of competency taxonomies. The competency taxonomies may be single or multi-level hierarchical classifications, which can include the classification of competencies universal to all supported organizations, as well as taxonomies specific to particular industries, business sectors, production processes, product offerings or business structure of particular supported organization. Competency taxonomies specific to particular supported organization can be sourced from its internal systems (product classification, company divisional structure, stages of production cycle, functional areas, etc). In any event, competency taxonomies may be selected and structured according to the needs of particular organization. The SkillCollider™ MDM module may be integrated with other MDM systems used within particular organizations. Competency taxonomies may be constantly maintained through an ongoing update process and particular competencies may be mapped to particular segments of taxonomies.

B: SkillCollider™ Deployment Instance

The SkillCollider™ deployment instance provides all or selected blocks of SkillCollider™ functionality to a particular supported organization (or parts of an organization). That is, certain functionality of a particular deployment instance could be disabled, limited or enhanced based on needs, policies, culture, strategic goals or management preferences of particular supported organization. All or some blocks of functionality can be deployed within technology infrastructure of particular organization (internal deployment) or outside of its technology infrastructure (external, or cloud-based deployment, “Software-as-a-Service” —SaaS or Software-as-a-Platform—SaaP). Separate instances supporting particular organizations could be integrated across to create a “Competency MarketPlace” across multiple organizations. Additionally, the functionality of SkillCollider™ could be integrated with the tools already used within organization. Each SkillCollider™ deployment instance may be configured to provide confidentiality, security, encryption and anonymity of data required by policies (and practices or management preferences) of a supported organization.

Major blocks of SkillCollider™ system functionality may include data acquisition. Data acquisition sources of SkillCollider™ data may include manual inputs or file uploads through, for example, one or more interfaces by the organization's user/expert, managers, human resource employees, and executives. Alternatively or additionally, the data may be retrieved from existing systems and/or platforms used within a supported organization. For example, the data may be obtained from one or more active human resource management systems or knowledge management systems, e.g., recruitment systems, talent management systems, career managements systems, learning and development systems, etc. The data may similarly be obtained from one or more third party platforms, such as master data management systems, social platforms and social intranets (e.g., MS SharePoint, . . . ), collaboration tools, financial systems, product processors and other systems.

As indicated herein, the data may be obtained using data crawlers or scraping robots. That is, data about organization's members and their competencies could be proactively gathered through a set of tools or procedures deployed within existing organization's infrastructure (i.e., routine scan of member's calendars, e-mails, social media postings, etc.). In this regard, the data crawlers will parse terms in documents and other digital content for exact or relevant matches to one or more terms in one or more predefined competency taxonomies. The system may therefore associate the particular member with a competency, group, organization, etc., based on the relevancy of the member's interactions to particular competencies, groups, organizations, etc. The data may similarly be obtained by parsing/scraping member resumes and public/private profiles, data from public domains (e.g., generally available on the Internet), recruitment companies or networks, such as Monster, Dice, Taleo, CareerNet, etc., professional networks and social media services, such as LinkedIn, Facebook, etc.

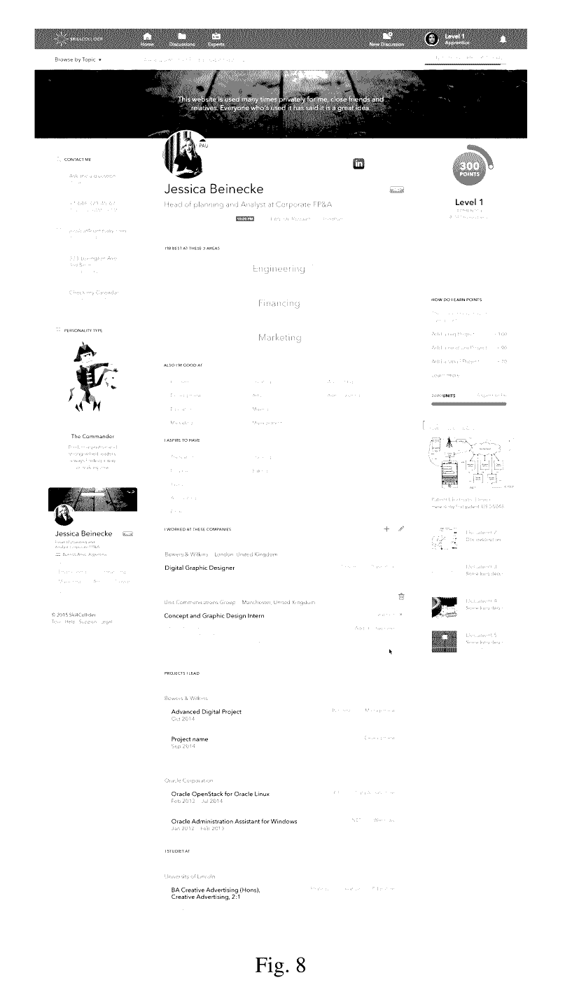

The competency profiles (as illustrated in FIG. 8) are generally built based on the data acquired through one or more of the sources noted above. Each data element sourced to a SkillCollider™ instance preferably has the following attributes: Source (where the data element came from or who input this value); Time Stamp (time when this value was sourced or changed); Validation By (who validated the values); Confidentiality designation (public data, SkillCollider™ Internal Data, restricted data, confidential data, etc.); and Data Format Validation. As indicated herein, these competency profiles are stored in one or more databases.

Another major block of the SkillCollider™ system functionality may include profiling. Profiling functionality generally allows association of multiple competencies with particular members of an organization. Users can define and validate their competency profiles based on: pre-populated data received from various sources described above; suggested competencies automatically generated by system; manager's or co-workers' inputs; and user's own manual inputs. Competency information internal to the organization may be merged with the information received from the sources external to the organization (example
competencies imported from LinkedIn through available API's). Population of competencies (associated with particular members) generally represents the “supply” of competencies offered by the members of organization (users of the system).

Another major block of the SkillCollider™ system functionality may include suggested competencies. Competencies may be suggested based on the analysis of acquired data about competencies of particular Member or his/her social interactions or occupational history, SkillCollider™ can automatically identify certain competencies and propose them for validation by the user, a co-worker or a manager.

Another major block of the SkillCollider™ system functionality may include search functionality allowing the user to search for people and/or competencies. The search functionality provides system users with capabilities to identify particular competencies offered by members of organization (or other organizations) and find the members (and associated content) who offer competencies or combinations of competencies required for particular types of engagements. Search can be performed through: dynamic filtering based on MDM competency categories and hierarchical competency taxonomies (‘faceted search’ or ‘navigated search’); and free-format or key-word search based on information indexed in SkillCollider™ database. Search for competencies represents ad-hoc “demand” for particular competencies. The search function allows users to search existing knowledge created by employees. This prior knowledge can be located in centralized “wiki's,” knowledge databases and libraries of documents that could be tagged with one or several competencies. This knowledge may also be located in prior interactions between two or more individuals in SkillCollider™, where skills, competencies or thematics were discussed. That is, all discussions and interactions between two or more individuals in the SkillCollider™ application (via its online chat or discussions board) may be saved in libraries and made searchable by other users to leverage any relevant content.

Another major block of the SkillCollider™ system functionality may include structured “opportunities.” The system provides functionality for users to define and structure an opportunity. An opportunity represents a competency or a combination of particular competencies required for particular engagement of defined duration. Opportunity may be defined by: type and duration of engagement; number of people (profiles) required for particular engagement; and competency profiles required. The opportunity can be defined in the system by the user/manager, executive, HR representative, etc. The opportunity or any portion of the opportunity may also be generated automatically by the system. For example, the system may parse documents (letters, emails, published open positions, etc.) in the system and determine there from that an individual or group may need to be referred to a member with a particular competency. Each opportunity would be verified against the validation rules aligned with the policies and preferences of a supported organization. Population of competencies corresponding to defined opportunities of particular duration represents structured “demand” for competencies.

Another major block of the SkillCollider™ system functionality may include matching people and opportunities. In this regard, the system is operable to match competency profiles to opportunities (fully or partially, based on a scoring algorithm). If an appropriate opportunity is identified matching the competency profile of particular user, this opportunity is ‘pushed’ into a user's task list and offered for the user's consideration as a ‘suggested opportunity.’ In this regard, the user is able to accept the opportunity and be included in the group of candidates for the opportunity. If the user does not accept, the system may note this fact and use the denial for future matching for the particular competency.

Another major block of the SkillCollider™ system functionality may include competency valuation. Both ad-hoc demand and structured demand for competencies may be logged and quantified within the system. Valuation of the competencies may take into account: balance of supply and demand for particular competencies in the competency “exchange” or competency “marketplace”; and the duration of engagements associated with particular competencies. The value of particular competencies can be established manually based on the logic agreed with the supported organization or preferably automatically calculated by system based on pre-defined algorithms.

Another major block of the SkillCollider™ system functionality may include goal setting. That is, in order to facilitate sharing (exchange) of knowledge (competencies) within an organization, promote social behavior of its members and integrate competency exchange platform with evaluation process existing within organization (for example, yearly evaluation process), the system may provide functionality for users to set goals and monitor their ongoing completion of their goals. Goals may be defined for the users based on requirements set for his/her knowledge sharing and knowledge acquisition within particular time period (typically month, quarter or year). Goals set for particular user may incorporate: cumulative time required to share competencies (example: minimum 100 hours for the year of 2014); particular competencies that need to be shared with other members (example: credit card pricing); types of engagements that member needs to participate in (example: 10 questions, 2 projects and 1 assignment); particular competencies that need to be obtained (example: Generally Accepted Accounting Principles (“GAAP”) accounting); level of expertise corresponding to particular competency that need to be improved (example: improve knowledge of ‘credit card pricing’ from ‘3-average’ to ‘4-specialist’ or ‘5-expert’). Goals could be defined and validated by: members, member's manager, organization's executives, HR representatives, etc. Completion of goals may be monitored and calculated by the system and the user would be informed about the level of completion through user interfaces or push-notifications.

Another major block of the SkillCollider™ system functionality may include rewards/incentives. In order to facilitate sharing (exchange) of knowledge (competencies) within organizations and promote social behavior of its members, users of system can be provided with various rewards and incentives for participation. Rewards/incentives can be ‘virtual’ (for example, ‘virtual coins’ or ‘scores’) or ‘real’ (for example, linkage of accumulated rewards to physical rewards, catalog selections, monthly salary or yearly bonus pay-outs, etc.). Rewards/incentives may be provided to users for: completion and maintenance of user profiles; sharing of competencies with other members; providing endorsements and validations; participation in social interactions; participation in various engagements of different length; completion of goals; and defining and structuring opportunities in the system. Rewards/incentives logic is typically agreed with the supported organizations.

Another major block of the SkillCollider™ system functionality may include validation and endorsements functionality. After an interaction or exchange (discussion, meeting, phone call, email exchange, etc.) users may have the option to confirm or endorse each other's competencies. These endorsements can be seen by other users and will be further indicators of the level of proficiency of a user a certain area of expertise or competency. One or multiple users can endorse other one or multiple users for one or multiple competencies. Endorsements can be accumulated.

Another major block of the SkillCollider™ system functionality may include activity logging. SkillCollider™ system will be logging all activities and tasks performed on each client instance as well as safe storage of data provided by its users: each activity or task might be associated to a date and timestamp and to additional codes or references to enable the system administrators to assess the system's performance in completing these tasks as well as enabling the system to be restored or rebooted in the case of technical issues. Tasks and activities include and are not limited to users' search queries, results to these search queries, input of new profile data, creation of a new discussion, input of new expertise or competencies by users, distribution of incentives and rewards, etc. Data to be safely stored includes data that has been submitted by its users in profiles, discussions, chats and other.

Another major block of the SkillCollider™ system functionality may include surveys and micro-surveys. In order for the SkillCollider™ system to remain up to date with the latest information about its users' competencies and expertise, the system can be setup to automatically send emails or other messages to its individual users requesting to confirm if self-reported competencies are still relevant and current, have been further developed or are no longer pertinent. Similarly, these automatic messages could invite users to self-report any new competencies that can be shared with other users.

C: Database Instance

The database instance is generally the main repository for the SkillCollider™ system information for the supported organization. Some of the features of the database may include having the data architecture integrated with MDM module—it could be deployed within infrastructure of a supported organization or externally (“cloud-based”); using the data internal to the organization as well as data from the sources external to a supported organization (public and nonpublic), however, separating data obtained through different sources for the purpose of confidentiality; providing encryption, data security, data segregation and confidentiality according to the policies and practices of a supported organization. Some of the key database objects may include “Skill”, “Person”, “Opportunity” (“Engagement”), “Interaction”, and “Reward”.

D: Visualization, Reporting and Analytics (Business Intelligence) Functionality

The visualization, reporting and analytics aspects of the system generally relate to the functionality of retrieve, analyze and report data stored in SkillCollider™ system. That is, the data maintained by the system is transformed into meaningful and useful information and/or statistics for analytics and decision-making purposes, e.g., to support business decisions by human resource function, managers and executives of a supported organization. SkillCollider™ can be configured to use: internal SkillCollider™ business intelligence (BI) tools; open-source publicly available BI Tools; and BI tools already deployed and used by the supported organization (for instance, enterprise performance management solutions). Interfaces of SkillCollider™ BI modules could be integrated with SkillCollider™ interfaces or provide stand-alone set of user interfaces. Anonymized data can also be extracted, collated, consolidated and analyzed outside of the organization to which the data belongs.

E: Social and Communication Functionality, Building Communities

This aspect of the system allows individual and group interactions between users of SkillCollider™ (within a supported organization or across multiple supported organizations). Key features might include the option to create groups of users who share a common interest or possess one or several competencies as disclosed herein. Groups may be used to create a support group and provide users with information supplied by other users participating in a group to be more efficient in their work and duties, support clients, or accelerate revenues. Key Features may also include integration with existing communication, social and collaboration tools used by particular supported organization (MS Outlook, MS Sharepoint, MS Link, PeopleFluent SocialText, Yammer, DrumTalk, River, etc.); individual and group interactions; establishment of groups; scheduling functionality; support for different means of communication used within supported organization: in-person (meetings, sessions, etc.), voice communication (telephone, teleconferencing, VOIP), video communication (video conferencing, tele-presence), online communication (online chat, etc.); tracking and logging interactions happening between the members of the supported organization; and retaining history of interactions between members.

Engagements represent a unit of competency sharing by a given member of a supported organization. Engagements happening between the users of SkillCollider™ system could be differentiated by their duration (or time commitment), for example: question, advice (up to 15 min); consultation (up to 30 mm); session: Problem-Solving Session, Brown-Bag Session, Learning Session, Expertise-Sharing Session, etc. (1-2 hours); presentation (up to 4 hours); Review (up to 8 hours); Training (up to 1 day); Sales Call (up to 1 day); Focus Group (up to 1 day); Workshop (up to 2 days); Course (up to 1 week); Working Group (up to 1 week); Task Force (Up to 8 weeks); Project (Up to 3 months); Assignment (up to 6 months); and Full-Time Job (longer than 6 months). Each engagement happening between members could be associated with one or several competencies. Following the engagements between members, SkillCollider™ provides functionality to provide feedback and endorsements for particular competencies of members.

F: SkillCollider™ User Interfaces

Key features of the user interfaces, such as those depicted in the present application, may include: consistent graphical representation of particular objects across all SkillCollider™ user interfaces (“Skill”, “Person”, “Opportunity”, “Engagement”, “Interaction”, “Reward”, “Suggested Opportunity”, “Administrative Tasks”); main user interface: purposefully designated main areas; cross-platform support; and multi-lingual support.

G: Data Consolidation, Analysis and Research

This aspect of the system may provide analysis and statistics of consolidated information across SkillCollider™ deployment instances; evaluation of a supported organization against MarketPlace; creation of “Competency Marketplace” across SkillCollider™ deployment instances; and creation of opportunities to sources particular competencies from outside of the supported organization. Some of the key features may include anonymized data received from particular organizations (deployment instances) to avoid confidentiality issues; maintaining confidentiality of the information based on policies and preferences of particular supported organizations; and consolidation of SkillCollider™ data is performed based on common Master Data Management.

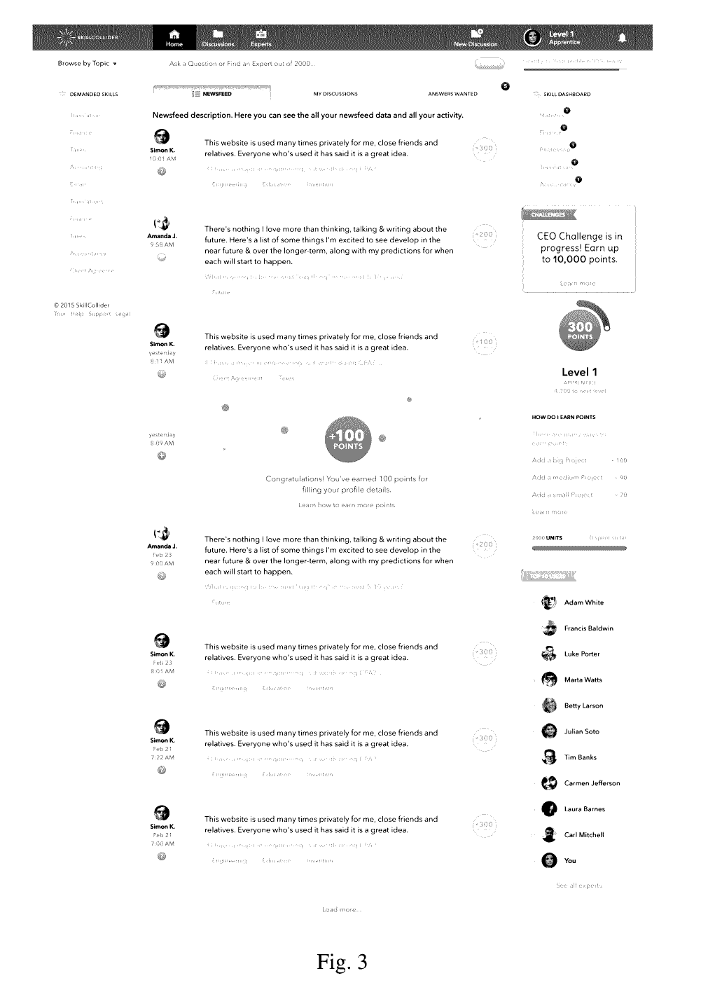

FIGS. 3-8 depict various interface screens that may be provided/provide the functionality discussed herein. FIG. 3 is an exemplary home screen for use with the system. The home screen includes a form element for the user to ask a question or submit a query (a competency need) for an expert. This page may further include news feed, my discussions, and answers wanted tab. The newsfeed is a sequential listing of the relevant news and user's activity. For example, the feed may include posts from other users (e.g., answering questions). Each of the posts may indicate the points earned for the post (e.g., for posting a questions, answering questions, etc.) and preferably the skills involved. The home page may also include a listing of skills in demand within the system. In this regard, the user may proactively reach out for engagements relevant to those skills.

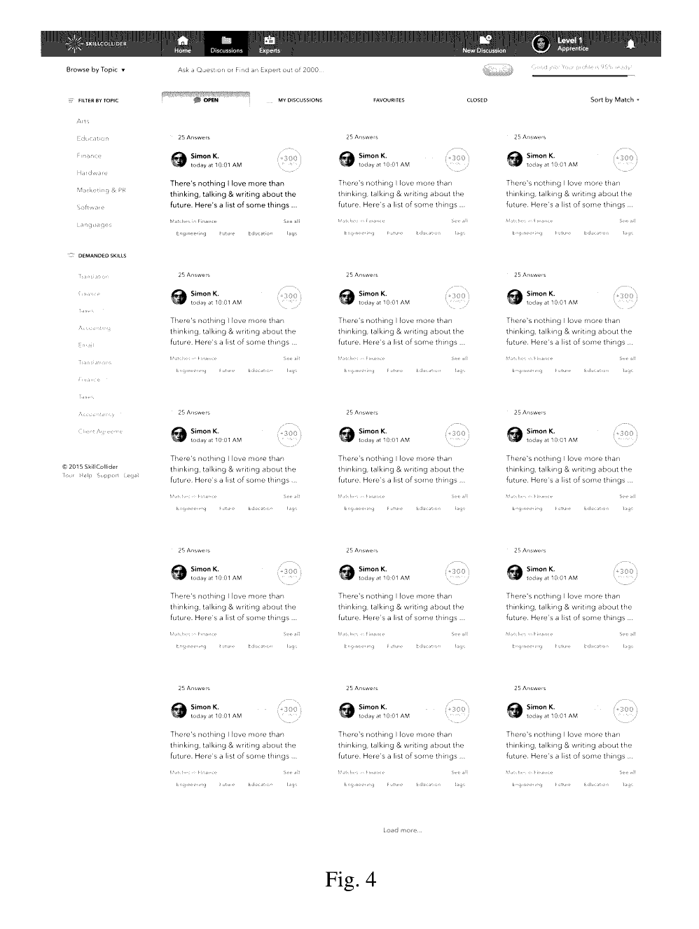

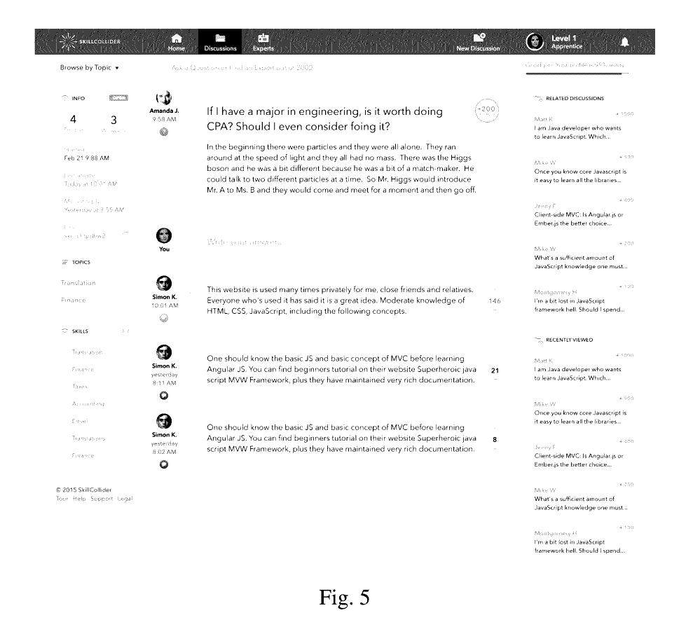

Referring to FIG. 4, the system may also maintain a discussions page, which generally provides a listing of the questions posted within the system. The questions may be filtered by topic, competence, etc. The questions may further be filtered by user (e.g., my discussions), favorite discussions, and closed discussions. The listing may also be generated in response to the user's question. In this regard, the system will receive a query from the user and populate the list of discussions relevant to the questions. The list may be sorted based on such relevance. Selecting one of the discussions may cause a particular discussion page, such as the page shown in FIG. 5. This page preferably includes a question and answer feed along with relevant data, such as the number of people involved in the discussion, skills involved, etc. The page may also include a navigation bar with a listing of related discussions.

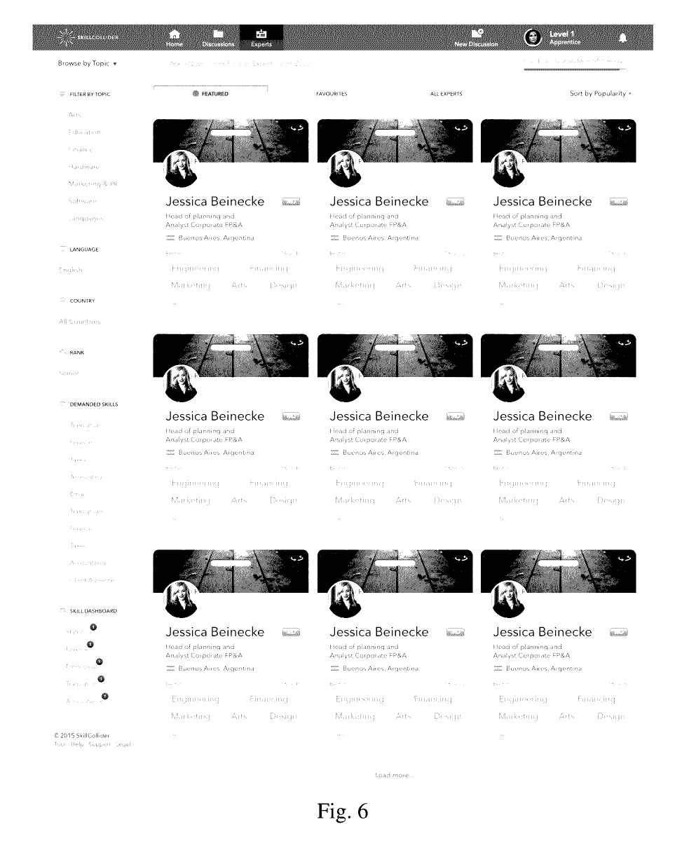

FIG. 6 shows a sample experts page. The experts page generally includes a listing of the experts for the organization. The listing may be filtered accordingly based on topic, competence, demographics, etc. Additionally, the listing may include a tab to filter featured experts or the user's favorite experts, or to expand to show all experts. An experts page may be generated in response to a query for an expert or a question posted by the user. In the first instance, the system may perform a search for experts with matching competence, such as technical, language, experience, etc. The listing of experts may be provided in various forms. In a preferred embodiment, each of the listings depicts the expert in the form of the user's badge.

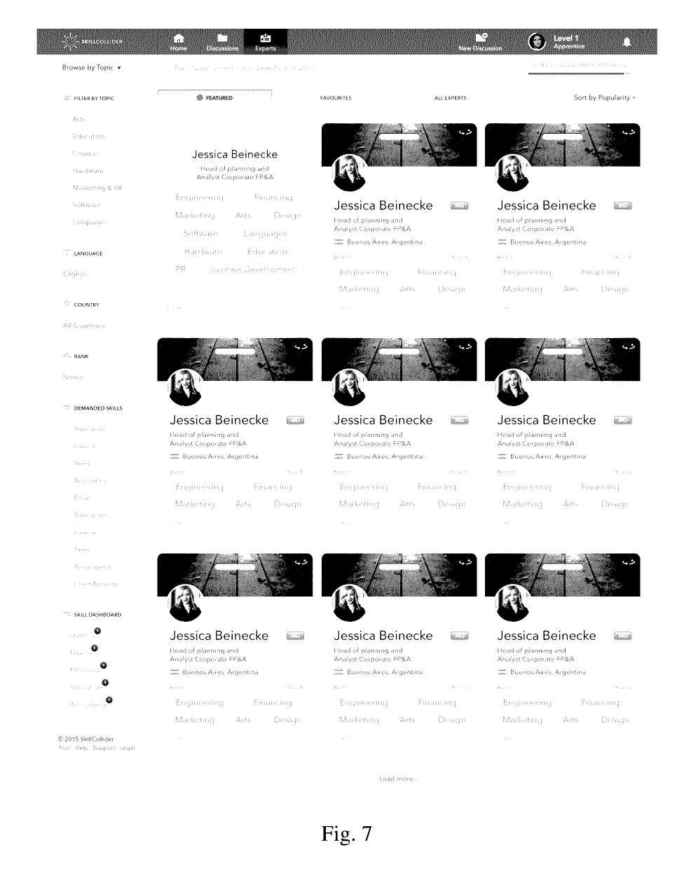

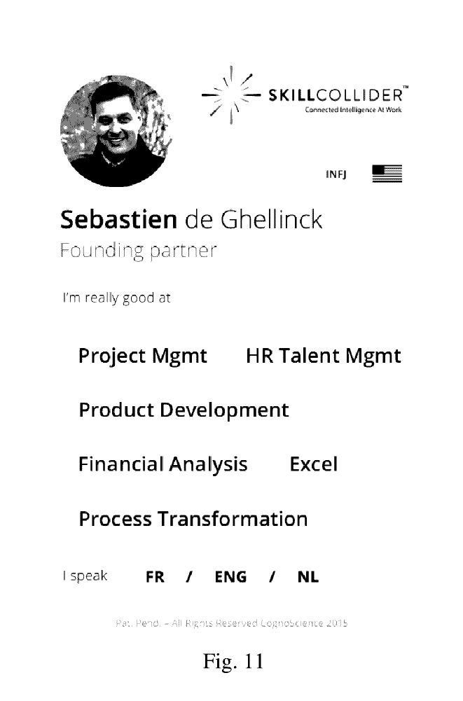

Skillbadge: The system may also interact with a skillbadge. This skillbadge is generally a representation where an individual's professional or personal information is displayed in a highly structured and visual way. A sample badge is shown in FIG. 11. This skillbadge is automatically generated by SkillCollider™, based on information provided or authorized by the individual user on the profile page interface (depicted in FIG. 8). The skillbadge generally includes the expert's name, position, location, competencies and mastered languages. The competencies are preferably filtered to show the expert's highest rated skills. The rear of a skillbadge preferably shows additional information, such as all or more of the expert's competencies, as shown in FIG. 7. The virtual skillbadges are preferably copies of the expert's physical badge. In this regard, the skillbadge would be a snapshot of an exhaustive resume so that one can immediately find out the skills, expertise and/or competencies of one's coworkers, for example, in a business meeting. That is, the skillbadge worn by the expert may include all of the data depicted on the interface screen, including the competencies. The physical skillbadge may be a laminated or printed card, or a compact device with a screen for depicting the badge. This allows the skillbadge to be updated with skills as the user's competencies. The physical skillbadge may also be a special purpose device with a memory, processor, and communication unit for exchanging information related to the user's badge with the main system. Alternatively or additionally, the skillbadge may be displayed on any ubiquitous device, such as a smart phone, computer tablet, card, access-card (‘corporate security badge’), business card, TV screen, computer screen etc.

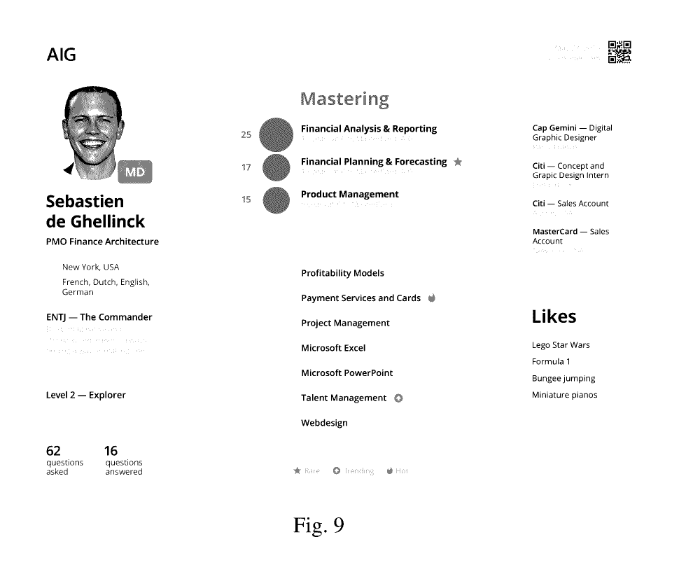

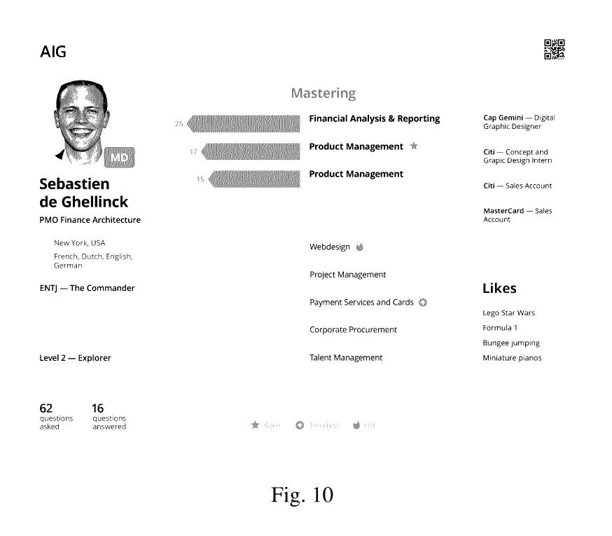

Skillboard: The system may also interact with a skillboard. The skillboard includes similar information that the skill badge includes, except that the board may be of larger size than the skill badge (e.g. size of 1 Letter or A4 format sheet of paper) and equipped to be pinned, stuck or placed at the user's workstation or office or in any location useful inside an organization or organizational documentation. This skillboard is automatically generated by SkillCollider™ for individual users or for an aggregation of coworkers (team or group), based on information provided or authorized by the individual or coworkers on the profile page(s) interface (depicted in FIG. 8). Exemplary skillboards are shown in FIGS. 9-10. Referring to FIGS. 9-10, the skillboard may include the expert's name and title, location, and personality (as well as a description of the personality). The board may also include the level of the particular expert in terms participation in the system, including answering and asking questions. In one embodiment, the board parses the expert's skills based on level of experience. For example, matters of greater experience may be categorized as mastered and ones with less than a threshold level of experience may be categorized as learning. Finally, prior positions held may be shown along with personal interests. This skillboards allow members of the organization to quickly understand the member's or group's skills, expertise and/or competencies as members walk past the expert's or group's space. In at least one embodiment, the skillbadge and skillboard include therein personality information about the user. The personality information may include a logo corresponding to one of a plurality of personality types. The personality information is generally stored along with the competency profile for use, e.g., in matching experts to engagements, groups, etc. The physical skillboard may also be a special purpose device with a memory, processor, and communication unit for exchanging information around the workplace. Alternatively or additionally, the skillboard may be displayed on any ubiquitous device, such as a smart phone, computer tablet, card, access-card (‘corporate security badge’), business card, TV screen, computer screen etc.

FIG. 8 depicts an expert's profile page. As can be seen, the profile page is closely aligned and connected with information found on the skill badge or skill board as well as other information relevant to the system. This profile data set may include personal information (name, ID, photo, etc.), corporate position information (position, department, symbol for officer title, location, time, etc.), personality profile (personality type, symbol, etc.), and/or skills/competencies (hard skills, aspiration skills, languages known, etc., extracted from a databank of competencies). This additional information may include a user level along with guidance for earning more points to reach the next level. In terms of the skills, the skills may be laid out in terms of the expert's proficiency. For example, the top three skills may be identified, with a separate listing of others skills. Finally, the user may include a listing of skills that the user aspires to be proficient in (goals).

The system may employ a matrix of personality types, e.g., so-called ‘16 personalities’. Each of these types may correspond to one of a plurality of personality logos. The matrix may be arranged such that the location of a personality on the matrix defines the personalities relative to personality traits, such as introvert vs. extravert, and sensing vs. intuitive. The logos/types may be used by the system in making recommendations for engagements, group member selection, etc. That is, the system may determine the appropriate personality that compliments members of an existing group/engagement.

The above mentions of Skillbadge and Skillboard should not be limiting. Other names have been anticipated such as MySkillBadge, MySkillBoard, MySkillpass, SkillPass, SkillTile, SkillSignal, SkillPass, SkillCompass, etc.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A system for building a competency exchange for an organization, the system comprising:
a processor; and
a memory having executable instructions stored thereon that when executed by the processor cause the processor to:
search a database of content for competency data associated with a plurality of individuals from an organization;
retrieve the competency data associated with the plurality of individuals from the organization based on a set of competency taxonomies;
generate profile information for the plurality of individuals by associating the individuals with the identified competency data;
receive a search query from a user of a client device, the search query specifying one or more competency criteria according to the competency taxonomies; and
identify one or more of the plurality of individuals associated with the one or more competency criteria based on the profile information.

2. The system of claim 1 wherein the profile information includes name, competencies, personality type, contact information, projects, documents associated with the individuals, and occupational history.

3. The system of claim 1 further comprising the processor identifying one or more of a plurality of individuals from outside the organization that are associated with the one or more competency criteria.

4. The system of claim 1 further comprising the processor generating an experts page in response to the search query.

5. The system of claim 4 wherein the experts page includes a plurality of skill badge data corresponding to the one or more plurality of individuals.

6. The system of claim 1 further comprising the processor generating skill badge and skill board data based on the profile information for the plurality of individuals.

7. The system of claim 6 wherein the skill badge and skill board data includes name, position, corporate information, and competency characteristics for an individual.

8. The system of claim 7 further comprising the processor filtering the competency characteristics for highest rated competency characteristics.

9. The system of claim 7 further comprising the processor identifying levels for the competency characteristics.

10. The system of claim 7 wherein the competency characteristics include personality types.

11. The system of claim 1 wherein the database of content includes electronic interactions between the plurality of individuals.

12. The system of claim 1 further comprising the processor transferring the skill badge and skill board data to a device including a screen, memory, processor, and a communication unit.

13. The system of claim 1 further comprising the processor storing the skill badge and skill board data in a card, badge or security badge.

14. The system of claim 1 further comprising the processor printing the skill badge and skill board data on paper.

15. The system of claim 1 wherein the search query comprises a question or consultation request posted by the user of the client device.

16. The system of claim 1 wherein the search query comprises an assignment, project, part-time or full-time opportunity or full-time job posted by the user of the client device.

17. The system of claim 1 further comprising the processor:
parsing a communication medium between parties for a given competency; and
determining a condition to refer individuals having profiles including the given competency to the parties.

18. The system of claim 1 further comprising the processor:
receiving endorsement of the competency data from endorsement data sources; and
generating validation points or rewards based on the endorsement.

19. The system of claim 1 further comprising the processor determining a demand for a given competency based at least one of an amount of profiles of individuals including the given competency, search queries specifying the given competency, and a duration of engagements associated with the given competency.
